(19) United States
(12) Patent Application Publication
(10) Pub. No.: US 2026/0015456 A1
(43) Pub. Date: Jan. 15, 2026

(54) POLYFUNCTIONAL VINYL RESIN, PRODUCTION METHOD THEREFOR, COMPOSITION OF POLYFUNCTIONAL VINYL RESIN, AND CURED OBJECT THEREFROM

(71) Applicants: NIPPON STEEL Chemical & Material Co., Ltd., Tokyo (JP); KUKDO CHEMICAL CO., LTD., Seoul (KR)

(72) Inventors: Masahiro SOH, Tokyo (JP); Kazuo ISHIHARA, Tokyo (JP); JOONGHWI JEE, Seoul (KR); KIHWAN YU, Seoul (KR); GA YOUNG LEE, Seoul (KR); HAERRY YOUN, Seoul (KR)

(73) Assignees: NIPPON STEEL Chemical & Material Co., Ltd., Tokyo (JP); KUKDO CHEMICAL CO., LTD., Seoul (KR)

(21) Appl. No.: 18/995,150

(22) PCT Filed: Jul. 6, 2023
(86) PCT No.: PCT/JP2023/025206

§ 371 Date: Jan. 16, 2025

(30) Foreign Application Priority Data
Jul. 22, 2022 (JP) 2022-117459

(51) Int. Cl. C08G 61/02; C08J 5/24

(52) U.S. Cl. CPC C08G 61/02; C08J 5/24; C08G 2261/728

(57) ABSTRACT

To provide a resin material exhibiting low permittivity and low dielectric tangent and also having high heat resistance while having high solvent solubility. A polyfunctional vinyl resin represented by the following general formula (1), wherein each R¹ independently represents a hydrocarbon group having 1 to 8 carbon atoms, each R² independently represents a hydrogen atom, or a dicyclopentenyl group, and at least one R² is a dicyclopentenyl group; each X represents a hydrogen atom or a vinyl group-containing group represented by the formula (1a), and at least one X is a vinyl group-containing group; R³ represents a hydrogen atom or an alkyl group or an alkenyl group having 1 to 8 carbon atoms; and n represents the number of repetitions and an average value thereof is a number of 1 to 5.

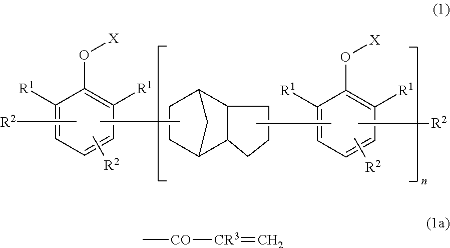

### TECHNICAL FIELD

The present invention relates to a polyfunctional vinyl resin and a polyfunctional vinyl resin composition having low dielectric tangent as well as high heat resistance useful for printed substrates, sealing materials, casting materials, and the like of electronic devices, and a cured product thereof.

### BACKGROUND ART

Information communication in high frequency bands has been actively performed along with an increase in the amount of information communication in recent years, and there have been required electrical insulation materials having superior electric properties, in particular, low permittivity and low dielectric tangent in order to reduce transmission loss in high frequency bands. Further, since printed substrates or electronic components using an electrical insulation material are exposed to solder reflow at high temperatures during mounting, a material having high heat resistance, that is, exhibiting a high glass transition temperature has been desired. In particular, lead-free solder having a high melting point has recently been used due to environmental concerns. Hence, a demand for an electrical insulation material having higher heat resistance has increased. To meet such demands, cured resins using vinyl resins with various chemical structures have conventionally been suggested.

As such cured resins, for example, cured resins such as a divinyl benzyl ether resin of bisphenol or a phenol novolac-type polyvinyl benzyl ether resin have been suggested (Patent Literature 1 and Patent Literature 2). However, these vinyl benzyl ether resins cannot provide sufficient dielectric properties, and also the heat resistance thereof is not sufficiently high.

Some vinyl benzyl ether resins having a specific structure have been suggested as vinyl benzyl ether resins in which those properties are improved, and attempts have been made to improve heat resistance (Patent Literature 3, Patent Literature 4, and Patent Literature 5). However, it cannot be said yet that the improvement in properties is sufficient, and further improvement in properties has been demanded.

A polyfunctional vinyl resin composition that contains a polyfunctional vinyl resin obtained by subjecting at least one hydroxyl group selected from the group consisting of a phenol aralkyl resin, a naphthol aralkyl resin, a biphenyl-type phenol novolac resin, and a biphenyl-type naphthol novolac resin to vinyl benzyl etherification is disclosed (Patent Literature 6). However, the vinyl benzyl etherified polyfunctional vinyl resin synthesized according to the method disclosed in Patent Literature 6 has a large total halogen content and a large amount of remaining vinyl aromatic halomethyl compound, and is thus unsatisfactory as an insulation material having dielectric tangent and heat resistance corresponding to high. The resin is also undesirable in terms of moldability, because molding defects easily occur.

It is known to subject a phenolic hydroxyl group of a polyfunctional phenylene ether oligomer obtained by reacting a polyhydric phenol having 3 or more and less than 9 phenolic hydroxyl groups per molecule and having an alkyl group or an alkylene group at 2- and 6-positions of at least one phenolic hydroxyl group among them with a monovalent phenolic compound, to vinyl benzylation (Patent Literature 7). However, the vinyl benzyl ether resin obtained by this technique has drawbacks such that the molding temperature is high due to its high viscosity and when the vinyl benzyl ether resin is exposed to high temperatures in an air atmosphere, its dielectric tangent largely deteriorates.

There have also been widely proposed techniques relating to methacrylic-terminated PPE in which a phenolic hydroxyl group of a polyfunctional phenylene ether (PPE) oligomer is capped with a methacrylic group. In order to enhance convenience during prepreg production, the molecular weight of PPE is decreased and/or PPE having a branched structure is used to increase the solubility in a solvent (Patent Literature 8 and Patent Literature 9). However, decreasing the molecular weight of PPE causes reductions in dielectric properties and heat resistance, and introducing branched structure also causes a limited effect of improving solvent solubility, and hence there is a demand for further improvement.

Thus, conventional vinyl resins do not give cured products having heat resistance satisfying low dielectric tangent after severe heat histories capable of withstanding lead-free soldering, required for electrical insulation material applications, in particular, electrical insulation material applications corresponding to high frequencies, and are also insufficient in terms of reliability and processability.

### CITATION LIST

### Patent Literatures

Patent Literature 1: JP 63-68537 A
Patent Literature 2: JP 64-65110 A
Patent Literature 3: JP 1-503238 A
Patent Literature 4: JP 9-31006 A
Patent Literature 5: JP2004-323730 A
Patent Literature 6: JP2003-306591 A
Patent Literature 7: JP2007-308685 A
Patent Literature 8: JP2003-515642 A
Patent Literature 9: JP2021-109944 A

### SUMMARY OF INVENTION

The problems of the present invention are to provide a vinyl resin and a resin composition that give a cured product having a high glass transition temperature while having high solvent solubility, low permittivity and dielectric tangent, and an object of the present invention is to provide a resin composition, a cured product, or a material containing the same that can be used as dielectric materials, insulation materials, and heat-resistant materials in the fields of electrical and electronic industries, space and aircraft industries, and the like.

To solve the above problems, the present inventors have intensively studied, and as a result, found that the problems can be solved by a polyfunctional vinyl resin represented by the following general formula (1), thereby completing the present invention.

In other words, the present invention relates to a polyfunctional vinyl resin represented by the following general formula (1):

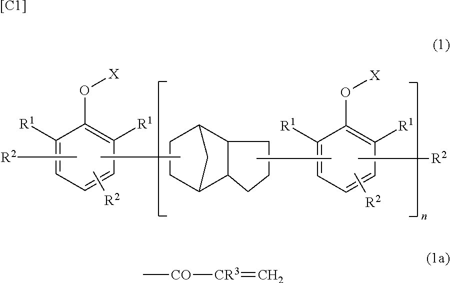

wherein
each R¹ independently represents a hydrocarbon group having 1 to 8 carbon atoms;
each R² independently represents a hydrogen atom, or a dicyclopentenyl group, and at least one R² is a dicyclopentenyl group;
each X independently represents a hydrogen atom or a vinyl group-containing group represented by the formula (1a), and at least one X is a vinyl group-containing group;
R³ represents a hydrogen atom or an alkyl group or an alkenyl group having 1 to 8 carbon atoms; and
n represents the number of repetitions and an average value thereof is a number of 1 to 5.

The present invention relates to a method for producing the polyfunctional vinyl resin including reacting dicyclopentadiene at a ratio of 0.23 to 2-fold moles with 2,6-disubstituted phenol represented by the following general formula (2), to obtain a polyvalent hydroxy resin represented by the following general formula (3), and then reacting the resulting polyvalent hydroxy resin with one or more of an acid anhydride or an acid halide represented by the following general formula (4):

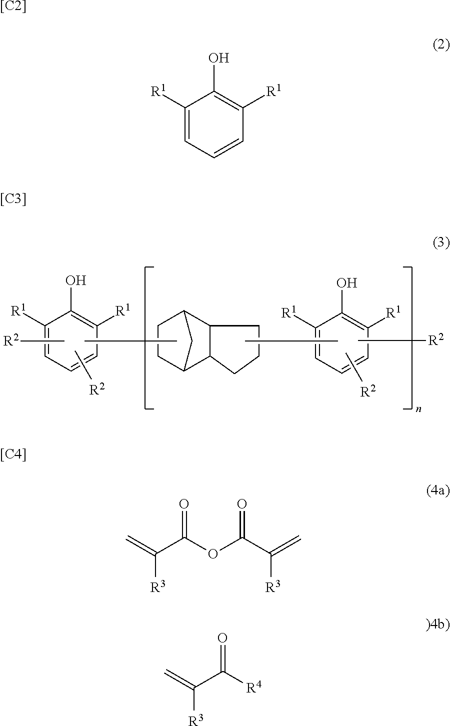

wherein
R¹, R², and n each have the same meaning as the definition in the general formula (1);
R³ has the same meaning as the definition in the formula (1a); and
R⁴ represents a halogen.

The present invention relates to a polyfunctional vinyl resin composition containing a polyfunctional vinyl resin and a radical polymerization initiator as essential components, and a polyfunctional vinyl resin-cured product obtained by curing the composition.

The present invention further relates to a prepreg including a semi-cured product of the polyfunctional vinyl resin composition, and a fibrous base material, a resin sheet including a support film, and a laminated board formed by lamination of the prepreg and/or the resin sheet.

The polyfunctional vinyl resin and the resin composition of the present invention have favorable solvent solubility, and a cured product obtained by further curing the resin composition has high heat resistance while having low permittivity and dielectric tangent and is useful as electronic materials for high-speed telecommunication.

### BRIEF DESCRIPTION OF DRAWINGS

FIG. 1 A GPC chart of a polyfunctional vinyl resin obtained in Example 1.

FIG. 2 An IR chart of the polyfunctional vinyl resin obtained in Example 1.

### DESCRIPTION OF EMBODIMENTS

Hereinafter, the present invention will be described in detail.

The polyfunctional vinyl resin of the present invention is represented by the following general formula (1):

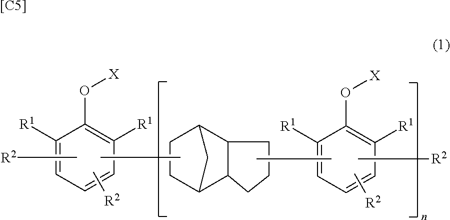

In the general formula (1), R¹ represents a hydrocarbon group having 1 to 8 carbon atoms, and is preferably an alkyl group having 1 to 8 carbon atoms, an aryl group having 6 to 8 carbon atoms, an aralkyl group having 7 to 8 carbon atoms, or an allyl group. The alkyl group having 1 to 8 carbon atoms may be any of linear, branched and cyclic groups, and examples thereof include hydrocarbon groups such as a methyl group, an ethyl group, a n-propyl group, an isopropyl group, a n-butyl group, a sec-butyl group, an isobutyl group, a t-butyl group, a n-pentyl group, an isopentyl group, a neopentyl group, a t-pentyl group, a methylbutyl group, a n-hexyl group, a dimethylbutyl group, a n-heptyl group, a methylhexyl group, a trimethylbutyl group, a n-octyl group, a dimethylpentyl group, an ethylpentyl group, an isooctyl group, and an ethylhexyl group, and cycloalkyl groups each having 5 to 8 carbon atoms, such as a cyclohexyl group, a cycloheptyl group, a cyclooctyl group, a methylcyclohexyl group, a dimethylcyclohexyl group, an ethylcyclohexyl group, and a methylcycloheptyl group, but not limited thereto. Examples of the aryl group having 6 to 8 carbon atoms include a phenyl group, a tolyl group, a xylyl group, and an ethylphenyl group, but not limited thereto. Examples of the aralkyl group having 7 to 8 carbon atoms include a benzyl group and an α-methylbenzyl group, but not limited thereto. Among these substituents, a methyl group or a phenyl group is preferable and a methyl group is particularly preferable from the viewpoints of availability, and reactivity of a cured product obtained.

Each R² independently represents a hydrogen atom, or a dicyclopentenyl group, and at least one R² is a dicyclopentenyl group. The dicyclopentenyl group is a group derived from dicyclopentadiene, and is represented by the following formula (1b) or formula (1c):

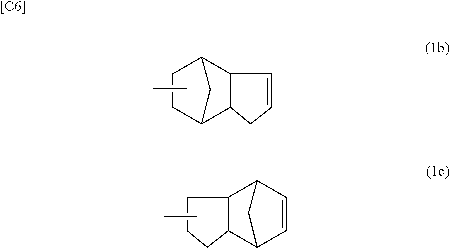

In the general formula (1), each X independently represents a hydrogen atom, or a vinyl group-containing group represented by the following formula (1a), and at least one X is a vinyl group-containing group which is a group derived from an acid anhydride or an acid halide as a raw material.

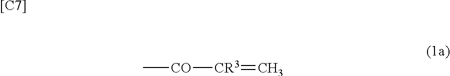

R³ represents a hydrogen atom or an alkyl group or an alkenyl group having 1 to 8 carbon atoms.

In the general formula (1), n represents the number of repetitions and a number of 1 or more, and an average value thereof represents a number of 1 to 5, preferably 1.1 to 4.0, more preferably 1.2 to 3.0, further preferably 1.3 to 2.0. The average value is a number average.

The average molecular weight of the polyfunctional vinyl resin of the present invention is preferably 500 to 5,000, more preferably 600 to 2,000 in terms of weight average molecular weight (Mw), and is preferably 300 to 3,000, more preferably 400 to 1,500, further preferably 450 to 1,000 in terms of number average molecular weight (Mn). The upper limit of the vinyl equivalent (g/eq) is preferably 600, more preferably 550, further preferably 500, particularly preferably 450, and the lower limit thereof is preferably 200, more preferably 220, further preferably 250, particularly preferably 300. On the other hand, the hydroxyl group equivalent (g/eq) is preferably in the range of 10,000 or more, more preferably 15,000 or more, particularly preferably 20,000 to 30,000.

In a molecular weight distribution, the content of an n=0 form is preferably 5 to 20% by area, preferably 7 to 15% by area, the content of an n=1 form is preferably 40 to 80% by area, preferably 50 to 70% by area, and the content of an n≥2 form is 15 to 40% by area, preferably 20 to 30% by area.

The polyfunctional vinyl resin of the present invention can be suitably obtained by reacting a polyvalent hydroxy resin represented by the following general formula (3) and an acid anhydride represented by the following general formula (4a) or an acid halide represented by the following general formula (4b):

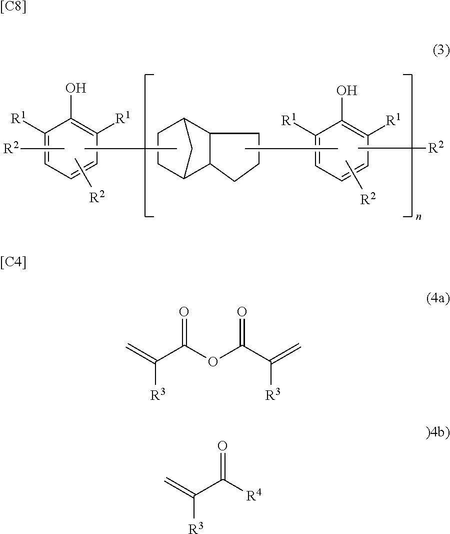

R¹, R², and n each have the same meaning as the definition in the general formula (1).
R³ represents a hydrogen atom or an alkyl group or an alkenyl group having 1 to 8 carbon atoms, and examples of the alkyl group include a methyl group, an ethyl group, a propyl group, a butyl group, a pentyl group, a hexyl group, a heptyl group, and an octyl group. Examples of the alkenyl group include a vinyl group, an allyl group, a butenyl group, a pentenyl group, a hexenyl group, a heptenyl group, and an octenyl group. R³ preferably represents a hydrogen atom or a methyl group from the viewpoints of availability, and reactivity of a cured product obtained.
R⁴ represents a halogen and is preferably a chlorine atom or a bromine atom.

The polyvalent hydroxy resin represented by the general formula (3) can be obtained by, for example, reacting a 2,6-disubstituted phenol compound represented by the following general formula (2) with dicyclopentadiene in the presence of a Lewis acid such as a boron trifluoride/ether complex.

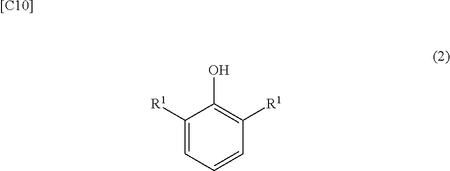

R¹ has the same meaning as the definition in the general formula (1).

Examples of the 2,6-disubstituted phenol compound include 2,6-dimethylphenol, 2,6-diethylphenol, 2,6-dipropylphenol, 2,6-diisopropylphenol, 2,6-di(n-butyl)phenol, 2,6-di(t-butyl)phenol, 2,6-dihexylphenol, 2,6-dicyclohexylphenol, 2,6-diphenylphenol, 2,6-ditolylphenol, 2,6-dibenzylphenol, 2,6-bis(α-methylbenzyl)phenol, 2-ethyl-6-methylphenol, 2-allyl-6-methylphenol, and 2-tolyl-6-phenylphenol, and 2,6-diphenylphenol and 2,6-dimethylphenol are preferable and 2,6-dimethylphenol is particularly preferable from the viewpoints of availability, and reactivity of a cured product obtained.

The catalyst for use in the reaction is a Lewis acid, is specifically, for example, boron trifluoride, a boron trifluoride/phenol complex, a boron trifluoride/ether complex, aluminum chloride, tin chloride, zinc chloride or iron chloride, and in particular, a boron trifluoride/ether complex is preferable in terms of ease of handling. In the case of a boron trifluoride/ether complex, the amount of the catalyst used is 0.001 to 20 parts by mass, preferably 0.5 to 15 parts by mass based on 100 parts by mass of the dicyclopentadiene.

The reaction method for introducing the dicyclopentenyl group into the 2,6-disubstituted compound is a method involving reacting dicyclopentadiene with the 2,6-disubstituted phenol compound at a predetermined ratio, and dicyclopentadiene may be continuously added and thus reacted, or may be added in several stages (divided to two or more portions and sequentially added) and thus intermittently reacted. The ratio is 0.23 to 2-fold moles of dicyclopentadiene per mol of the 2,6-disubstituted phenol compound.

In the case where dicyclopentadiene is continuously added and thus reacted, the ratio is 0.25 to 1-fold mole, preferably 0.28 to 1-fold mole, more preferably 0.3 to 0.5-fold moles of dicyclopentadiene per mol of the 2,6-disubstituted phenol compound. In the case where dicyclopentadiene is divided and sequentially added, and thus reacted, the ratio as whole is preferably 0.23 to 2-fold moles, more preferably 0.23 to 1.7-fold moles. The ratio of use of dicyclopentadiene at each stage is preferably 0.1 to 1-fold mole. The unreacted 2,6-disubstituted phenol compound may also be recovered in the middle of the reaction.

Preferably, dicyclopentadiene is divided to two or more portions and sequentially added in order to introduce dicyclopentadiene as a main chain and then introduce a dicyclopentadienyl group as a side chain R².

In this reaction, not only an isomer having a different substitution position, but also a structure where a dicyclopentadiene structure and the hydroxyl group of phenol are bonded may be included.

The method for confirming introduction of a dicyclopentenyl group into the polyvalent hydroxy resin represented by the general formula (3), used here, can be mass spectrometry (MS) or a Fourier transform infrared spectrophotometer (FT-IR) measurement method.

In the case of use of mass spectrometry, electrospray mass spectrometry (ESI-MS), a field desorption method (FD-MS), or the like can be used. Such introduction of a dicyclopentenyl group can be confirmed by subjecting a sample from which a component different in number of nucleus bodies is separated by GPC or the like, to mass spectrometry.

In the case of use of a FT-IR measurement method, a sample film-attached cell obtained by coating a KRS-5 cell with a sample dissolved in an organic solvent such as tetrahydrofuran (THF) and drying the organic solvent is measured by FT-IR, thereby allowing a peak assigned to C—O stretching vibration in a phenol nuclear to appear around 1210 cm⁻¹, and allowing a peak assigned to C—H stretching vibration of an olefin moiety in a dicyclopentadiene backbone to appear around 3040 cm⁻¹ only in the case of a dicyclopentenyl group being introduced. An olefin moiety of dicyclopentadiene incorporated in a main chain disappears and thus is not detected, and only olefin of a dicyclopentenyl group introduced as a side chain R² can be measured. When one obtained by linearly connecting the start and the end of an objective peak is defined as a baseline and the length from the top of the peak to the baseline is defined as a peak height, the amount of a dicyclopentenyl group introduced can be quantitatively determined by the ratio (A₃₀₄₀/A₁₂₁₀) between the peak (A₃₀₄₀) around 3040 cm⁻¹ and the peak (A₁₂₁₀) around 1210 cm⁻¹. It can be confirmed that a larger ratio means a more favorable physical property value, and a preferable ratio (A₃₀₄₀/A₁₂₁₀) for allowing objective physical properties to be satisfied is 0.05 or more, more preferably 0.10 or more, in particular, 0.10 to 0.30.

The hydroxyl group equivalent (g/eq.) of a polyfunctional hydroxy resin is preferably 150 to 500, more preferably 200 to 350. The average molecular weight is preferably 400 to 2,000, more preferably 500 to 2,000 in terms of weight average molecular weight (Mw), and is preferably 350 to 1,000, more preferably 400 to 800 in terms of number average molecular weight (Mn). The softening point is preferably 70 to 150° C., more preferably 80 to 120° C.

The reaction method is favorably made in a manner where 2,6-disubstituted phenol and a catalyst are loaded into a reactor and dicyclopentadiene is dropped over 1 to 10 hours.

The reaction temperature is preferably 50 to 200° C., more preferably 100 to 180° C., further preferably 120 to 160° C. The reaction time is preferably 1 to 10 hours, more preferably 3 to 10 hours, further preferably 4 to 8 hours.

After completion of the reaction, the catalyst is deactivated by addition of an alkali such as sodium hydroxide, potassium hydroxide, or calcium hydroxide. Thereafter, a solvent, for example, an aromatic hydrocarbon compound such as toluene or xylene or a ketone compound such as methyl ethyl ketone or methyl isobutyl ketone is added for dissolution, the resultant is washed with water, thereafter the solvent is recovered under reduced pressure, and thus an objective phenol resin can be obtained. Preferably, the dicyclopentadiene is reacted in the entire amount as much as possible, and one portion of 2,6-disubstituted phenol is unreacted, preferably 10% or less thereof is unreacted and recovered under reduced pressure.

During the reaction, a solvent, for example, an aromatic hydrocarbon compound such as benzene, toluene or xylene, a halogenated hydrocarbon compound such as chlorobenzene or dichlorobenzene, an ether compound such as ethylene glycol dimethyl ether or diethylene glycol dimethyl ether, or a ketone compound such as methyl isobutyl ketone, cyclopentanone, or cyclohexanone may be used, if necessary, depending on the viscosity adjustment or the like.

The polyfunctional vinyl resin of the present invention can be suitably obtained by reacting the polyvalent hydroxy resin thus obtained, with an acid anhydride or an acid halide.

Examples of the acid anhydride include acrylic anhydride and methacrylic anhydride, and methacrylic anhydride is preferable. Examples of the acid halide include acrylic chloride, methacrylic chloride, and methacrylic bromide, and methacrylic chloride and methacrylic bromide are preferable.

Examples of the reaction between the polyvalent hydroxy resin and the acid anhydride or the acid halide include a method involving reacting the polyvalent hydroxy resin in a solvent, in the presence of a basic compound. In this case, the reaction is favorably made in a manner where the polyvalent hydroxy resin, the basic compound and the solvent are loaded into a reactor and dissolved, and then the acid anhydride or the acid halide is added and reacted.

As for the use ratio of the polyvalent hydroxy resin and the acid anhydride or the acid halide, the reaction is made so that the acid anhydride or the acid halide can be preferably 0.5 to 2.0 equivalents, more preferably 0.8 to 1.5 equivalents per equivalent of the phenolic hydroxyl group of the polyvalent hydroxy resin.

The solvent used in the production of the polyfunctional vinyl resin of the present invention is not particularly limited, and examples thereof include aromatic hydrocarbons such as benzene, toluene, and xylene; halogenated hydrocarbons such as chlorobenzene and dichlorobenzene; ethers such as ethylene glycol dimethyl ether and diethylene glycol dimethyl ether; ketones such as acetone, methyl ethyl ketone, methyl isobutyl ketone, cyclopentanone, and cyclohexanone; alcohols such as methanol, ethanol, n-propanol, isopropanol, and n-butanol; ethers such as tetrahydrofuran, dioxane, and diglyme; and aprotic polar solvents such as dimethylacetamide, dimethylformamide, and dimethylsulfoxide. One or two or more solvents can be used from these compounds. In addition, water may be used by mixing with a solvent.

The amount of the solvent used is preferably 20 to 300% by mass, more preferably 25 to 250% by mass, particularly preferably 25 to 200% by mass, based on the total mass of the polyvalent hydroxy resin. In particular, since the aprotic polar solvent is not useful for purification such as washing with water, has a high boiling point, and is difficult to be removed, it is not preferable that the amount thereof used be more than 300% by mass based on the total mass of the polyvalent hydroxy resin.

The basic compound used for the production of the polyfunctional vinyl resin of the present invention is preferably an organic base compound, an alkali metal hydroxide, a carbonate, or the like. Specific examples thereof include triethylamine, diisopropylethylamine, pyridine, dimethylaminopyridine, sodium hydroxide, potassium hydroxide, potassium carbonate, and sodium carbonate, and sodium hydroxide, potassium hydroxide, triethylamine, and dimethylaminopyridine are preferable.

The amount of the basic compound used is usually 1.0 to 2.5 mol, preferably 1.0 to 1.8 mol, more preferably 1.0 to 1.5 mol per mol of a phenolic hydroxyl group of the polyvalent hydroxy resin.

The reaction temperature in the production of the polyfunctional vinyl resin of the present invention is usually 15 to 90° C., preferably 35 to 80° C. To obtain a polyfunctional vinyl resin having a higher purity, the reaction temperature is preferably raised in two stages or more, and for example, it is particularly preferable to set the first stage to 15 to 50° C. and the second stage to 45 to 80° C.

The reaction time in the production of the polyfunctional vinyl resin of the present invention is usually 0.5 to 10 hours, preferably 1 to 8 hours, particularly preferably 1 to 5 hours. When the reaction time is 0.5 hours or more, the reaction sufficiently proceeds, and when it is 10 hours or less, the amount of the by-product produced can be suppressed.

When self-polymerization of the acid anhydride or the acid halide is concerned, a polymerization inhibitor such as a quinone, a nitro compound, a nitrophenol compound, a nitroso compound, a nitrone compound, a phenol compound, or oxygen may be used.

After completion of the reaction, the solvent is distilled off under heating and reduced pressure and then dissolved in a solvent such as a ketone solvent having 4 to 7 carbon atoms (e.g., methyl isobutyl ketone, methyl ethyl ketone, cyclopentanone, cyclohexanone, or methylcyclohexanone) or an aromatic hydrocarbon solvent such as benzene, toluene, or xylene, or directly dissolved therein without being distilled off, water or a lower alcohol such as methanol, low in solubility in an objective product, or a mixed solvent thereof is added to perform washing, and thus the salt as a by-product and impurities can be removed.

The polyfunctional vinyl resin of the present invention is usually produced while blowing inert gas such as nitrogen into the system (into air or liquid). By performing the reaction while blowing inert gas into the system, the product to be obtained can be prevented from being colored.

The amount of inert gas blown per unit hour varies depending on the volume of a vessel to be used in the reaction. For example, the amount of inert gas blown per unit hour is preferably adjusted so that the volume of the vessel can be replaced for 0.5 to 20 hours.

The polyfunctional vinyl resin of the present invention can be cured alone, and is also suitably used as a polyfunctional resin composition in which various additives are compounded. For example, the polyfunctional vinyl resin of the present invention can be cured by compounding a radical polymerization initiator to promote curing.

The resin composition of the present invention is cured by the crosslinking reaction caused by a means such as heating as described below, and for example, a radical polymerization initiator (also referred to as a radical polymerization catalyst) may be contained therein and used as the radical polymerization initiator for the purpose of reducing the reaction temperature during curing or promoting the crosslinking reaction of the unsaturated group. The amount of the radical polymerization initiator to be used for this purpose is preferably 0.01 to 12 parts by mass, more preferably 0.1 to 8 parts by mass based on 100 parts by mass of the polyfunctional vinyl resin. The radical polymerization initiator is a radical polymerization catalyst, and thus the radical polymerization initiator is hereinafter representatively designated.

Specific examples of the radical polymerization initiator include peroxides such as benzoyl peroxide, cumene hydroperoxide, 2,5-dimethylhexane-2,5-dihydroperoxide, 2,5-dimethyl-2,5-di(t-butylperoxy)hexine-3, di-t-butyl peroxide, t-butylcumyl peroxide, α,α′-bis(t-butylperoxy-m-isopropyl)benzene, 2,5-dimethyl-2,5-di(t-butylperoxy)hexane, dicumyl peroxide, di-t-butyl peroxyisophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl) peroxide, and trimethylsilyl triphenylsilyl peroxide, but not limited thereto. Although it is not a peroxide, 2,3-dimethyl-2,3-diphenylbutane can also be used as the radical polymerization initiator (or the polymerization catalyst). However, the catalyst and radical polymerization initiator used in curing of the present resin composition are not limited to these examples.

As polyfunctional vinyl resin of the present invention, other vinyl resins or other thermal polyfunctional vinyl resins can be compounded. Examples thereof include a vinyl ester resin, a polyvinyl benzyl resin, a polyallyl resin, an epoxy resin, an oxetane resin, a maleimide resin, an acrylate resin, a polyester resin, a polyurethane resin, a polycyanato resin, a phenol resin, and a benzoxazine resin.

Thermoplastic resins such as a polystyrene resin, a polyphenylene ether resin, a polyetherimide resin, a polyethersulfone resin, a PPS resin, a polycyclopentadiene resin, and a polycycloolefin resin; thermoplastic elastomers such as a styrene-ethylene-propylene copolymer, a styrene-ethylene-butylene copolymer, a styrene-butadiene copolymer, a styrene-isoprene copolymer, a hydrogenated styrene-butadiene copolymer, and a hydrogenated styrene-isoprene copolymer; and rubbers such as polybutadiene and polyisoprene can also be compounded.

When the vinyl resin that can be compounded corresponds to one or more vinyl compounds each having one or more polymerizable unsaturated hydrocarbon groups in the molecule, the type(s) is/are not particularly limited. In other words, any vinyl compound may be adopted as the vinyl compound as long as it can be reacted with the polyfunctional vinyl resin of the present invention to form crosslinking and provide curing. A compound in which the polymerizable unsaturated hydrocarbon group is a carbon-carbon unsaturated double bond is more preferable, and a compound having two or more carbon-carbon unsaturated double bonds in its molecule is more preferable.

The average number of carbon-carbon unsaturated double bonds per molecule of the vinyl compound as a curable resin (number of vinyl groups (including substituted vinyl groups), also referred to as “number of terminal double bonds”) differs depending on the Mw of the vinyl compound, and is, for example, preferably 1 to 20, more preferably 2 to 18. If the number of terminal double bonds is too small, sufficient heat resistance of a cured product tends to be hardly obtained. If the number of terminal double bonds is too large, reactivity is excessively increased, thereby possibly resulting in the occurrence of failures, for example, a reduction in retention stability of a composition and/or a reduction in fluidity of a composition.

Examples of the vinyl compound include a trialkenyl isocyanurate compound such as triallyl isocyanurate (TAIC), modified polyphenylene ether (PPE) whose terminal is modified by a (meth)acryloyl group or a styryl group, a polyfunctional (meth)acrylate compound having two or more (meth)acryloyl groups in its molecule, a vinyl compound (polyfunctional vinyl compound) having two or more vinyl groups in its molecule, such as polybutadiene, and a vinylbenzyl compound such as styrene or divinylbenzene. Among them, one having two or more carbon-carbon double bonds in its molecule is preferable, and specific examples thereof include TAIC, a polyfunctional (meth)acrylate compound, a modified PPE resin, a polyfunctional vinyl compound, and a divinylbenzene compound. It is considered that these are used to more suitably form crosslinking by a curing reaction, and heat resistance of a cured product of a resin composition can be more enhanced. These may be used singly or in combinations of two or more kinds thereof. A compound having one carbon-carbon unsaturated double bond in its molecule may also be used in combination. Examples of the compound having one carbon-carbon unsaturated double bond in its molecule include a compound having one vinyl group in its molecule (monovinyl compound).

Various known flame retardants can be each used in the polyfunctional vinyl resin composition of the present invention, for the purpose of an enhancement in flame retardance of a cured product obtained, within a range of not reducing reliability. Examples of such a usable flame retardant include a halogen-based flame retardant, a phosphorus-based flame retardant, a nitrogen-based flame retardant, a silicone-based flame retardant, an inorganic flame retardant and an organic metal salt-based flame retardant. A halogen-free flame retardant is preferable and a phosphorus-based flame retardant is particularly preferable, from the viewpoint of the environment. Such flame retardants may be used singly, those of the same system may be used in combinations of two or more kinds, or those of different systems may be used in combinations.

In the polyfunctional vinyl resin composition of the present invention, components other than those mentioned above (in the present invention, sometimes referred to as “other components”) may be contained for the purpose of further enhancement in its functionality. Examples of such other components include a filler, an ultraviolet protection agent, an antioxidant, a coupling agent, a plasticizer, a flux, thixotropy imparting agent, a lubricating agent, a colorant, a pigment, a dispersing agent, an emulsifier, a low viscoelasticity imparting agent, a release agent, a defoamer, and an ion trapping agent.

Examples of the filler include inorganic fillers such as fused silica, crystalline silica, alumina, silicon nitride, boron nitride, aluminum nitride, aluminum hydroxide, calcium hydroxide, magnesium hydroxide, boehmite, talc, mica, clay, calcium carbonate, magnesium carbonate, barium carbonate, zinc oxide, titanium oxide, magnesium oxide, magnesium silicate, calcium silicate, zirconium silicate, barium sulfate, and carbon; fibrous fillers such as carbon fiber, glass fiber, alumina fiber, silica alumina fiber, silicon carbide fiber, polyester fiber, polyamide fiber, cellulose fiber, aramid fiber, and ceramic fiber; and fine particle rubber.

Examples of other components include quinacridone-based, azo-based, and phthalocyanine-based organic pigments; inorganic pigments such as titanium oxide, a metal foil pigment, and an anticorrosive pigment; hindered amine-based, benzotriazole-based, and benzophenone-based ultraviolet absorbers; hindered phenol-based, phosphorus-based, sulfur-based, and hydrazide-based antioxidants; release agents such as stearic acid, palmitic acid, zinc stearate, and calcium stearate; and additives such as a leveling agent, a rheology controlling agent, a pigment dispersing agent, a cissing inhibitor, and a defoamer. The amount of these other components compounded is preferably in the range of 0.01 to 20% by mass based on the solid content in the resin composition.

The polyfunctional vinyl resin composition of the present invention can be dissolved in a solvent, to thereby produce a resin varnish. Examples of the solvent include methyl ethyl ketone, acetone, toluene, xylene, tetrahydrofuran, dioxolane, dimethylformamide, methyl isobutyl ketone, methoxy propanol, cyclohexanone, methyl cellosolve, ethyl diglycol acetate, propylene glycol monomethyl ether acetate, and γ-butyrolactone, and the selection and proper amount of use thereof can be appropriately selected depending on applications. For example, a solvent having a boiling point of 160° C. or less, such as methyl ethyl ketone, acetone, toluene, xylene, or 1-methoxy-2-propanol is preferable in printed wiring board applications, and the solvent is preferably used in a proportion such that the non-volatile content can be 20 to 80% by mass. On the other hand, in build-up adhesion film applications, for example, ketones such as acetone, methyl ethyl ketone, and cyclohexanone; ester compounds such as ethyl acetate, butyl acetate, cellosolve acetate, propylene glycol monomethyl ether acetate, carbitol acetate, and γ-butyrolactone; carbitols such as cellosolve and butylcarbitol; aromatic hydrocarbons such as toluene and xylene; dimethylformamide, dimethylacetamide, and N-methylpyrrolidone can be preferably used, and are preferably used in a proportion such that the non-volatile content can be 20 to 80% by mass. The laminated board of the present invention can be obtained by curing the resin varnish. Specific examples thereof include a printed-wiring substrate, a printed-circuit board, a flexible printed-wiring board, and a build-up wiring board.

The cured product obtained by curing the polyfunctional vinyl resin composition of the present invention can be used as a shaped product, a laminated product, a cast product, an adhesive, a coating film, and a film. For example, the cured product of a semiconductor sealing material is a cast product or a shaped product. As for the method for obtaining a cured product for this application, the compound is molded using a cast, a transfer molding machine, an injection molding machine, or the like, and further heating the molded product at 80 to 230° C. for 0.5 to 10 hours, to thereby obtain a cured product. In addition, the cured product of the resin varnish is a laminated product. As for the method for obtaining the cured product, base materials such as the above fibrous filler or paper are impregnated with the resin varnish, heated, and dried to obtain prepregs, a single prepreg is laminated with another single one or a metal foil such as a copper foil, and the laminate is subjected to hot press molding, to thereby obtain a cured product. In addition, an uncured sheet or a partially cured sheet of the polyfunctional vinyl resin composition of the present invention can be suitably used as, for example, a build-up film, a bonding sheet, a coverlay sheet, a bump sheet for flip chip bonders, and an insulating layer or adhesion layer for substrates.

The polyfunctional vinyl resin composition of the present invention is useful as a material for electronic components, in particular, a material for high frequency electronic components by compounding inorganic high dielectric powder such as barium titanate or an inorganic magnetic material such as ferrite.

Then, the prepreg of the present invention and the cured product thereof will be described. To enhance mechanical strength and increase dimension stability, a base material is added to the prepreg of the present invention.

As such a base material, cloths and papers, for example, various glass cloths such as woven roving, cloth, chopped mat, and surfacing mat; asbestos cloth, metal fiber cloth, and other synthetic or natural inorganic fiber cloths; woven fabrics or non-woven fabrics obtained from liquid crystal fibers such as wholly aromatic polyamide fiber, wholly aromatic polyester fiber, and polybenzazole fiber; woven fabrics or non-woven fabrics obtained from synthetic fibers such as polyvinyl alcohol fiber, polyester fiber, and acrylic fiber; natural fiber cloths such as cotton cloth, hemp cloth, and felt; and natural cellulose cloths such as carbon fiber cloth, craft paper, cotton paper, and paper-glass mixed paper can be used each singly or in combinations of two or more.

The proportion of the base material may be 5 to 90% by mass, is preferably 10 to 80% by mass, further preferably 20 to 70% by mass in the prepreg. When the base material is less than 5% by mass, the dimension stability and strength of the cured product tend to be reduced. When the proportion of the base material is more than 90% by mass, dielectric properties of the cured product tend to be reduced.

In the prepreg of the present invention, a coupling agent can be used for the purpose of improving adhesiveness at the interface of the resin and the base material, if necessary. As the coupling agent, a common coupling agent such as a silane coupling agent, a titanate coupling agent, an aluminum-based coupling agent, or a zircoaluminate coupling agent can be used.

Examples of the method for producing the prepreg of the present invention include a method in which the polyfunctional vinyl resin composition of the present invention and, if necessary, other components are uniformly dissolved or dispersed in, for example, the above-described aromatic or ketone-based solvent, or a mixed solvent thereof, a base material is impregnated therewith and then dried. Impregnation is performed by immersion (dipping), coating, or the like. Impregnation can be repeated a plurality of times if necessary, and at this time, impregnation can be repeated using a plurality of solutions each having a different composition and concentration, to thereby adjust the resin composition and the amount of resin to finally intended ones.

A cured product can be obtained by curing the prepreg of the present invention by a method such as heating. The production method thereof is not particularly limited, and for example, a plurality of prepregs can be stacked, and layers can be adhered and simultaneously subjected to heat curing under heating and pressurization to obtain a cured product (laminated board) having a desired thickness. It is also possible to combine a cured product adhered and cured once and the prepreg to obtain a multilayer laminate having a novel layer structure. Laminate forming and curing are usually simultaneously performed using a heat press or the like, and each of them may be performed singly. That is, an uncured or semi-cured prepreg obtained by laminate forming in advance can be subjected to heat treatment or treatment by another method to be thereby cured.

Forming and curing can be performed, for example, in the ranges of a temperature: 80 to 300° C., a pressure: 0.1 to 1,000 kgf/cm², and a time: 1 minute to 10 hours, more preferably in the ranges of a temperature: 150 to 250° C., a pressure: 1 to 500 kgf/cm², and a time: 1 minute to 5 hours.

The laminate of the present invention is constituted of a layer of the prepreg of the present invention and a metal foil layer. Examples of the metal foil used herein include a copper foil and an aluminum foil. The thickness thereof is not particularly limited, and is in the range of 3 to 200 μm, more preferably 3 to 105 μm.

Examples of the method for producing the laminate of the present invention include a method in which the prepreg obtained from the polyfunctional vinyl resin composition of the present invention and the base material described above and a metal foil are laminated in a layer structure according to purpose, and layers are adhered and simultaneously subjected to heat curing under heating and pressurization. In the laminate of the polyfunctional vinyl resin composition of the present invention, the cured product and the metal foil are laminated in an arbitrary layer structure. The metal foil can be used as both a surface layer and an intermediate layer. In addition, it is possible to form a multilayer by repeating lamination and curing a plurality of times.

In adhesion with the metal foil, an adhesive can be used. Examples of the adhesive include epoxy-based, acrylic, phenolic, and cyanoacrylate-based adhesives, but are not particularly limited thereto. Laminate forming and curing described above can be performed under the same conditions as the production of the cured product of the prepreg of the present invention.

It is also possible to form the polyfunctional vinyl resin composition of the present invention into a film. The thickness thereof is not particularly limited, and is in the range of 3 to 200 μm, more preferably 5 to 105 μm.

Examples of the method for producing the film of the present invention include, but are not particularly limited to, a method in which the polyfunctional vinyl resin composition and, if necessary, other components are uniformly dissolved or dispersed in, for example, an aromatic or a ketone-based solvent, or a mixed solvent thereof, and a resin film such as a PET film is coated therewith and then dried. Coating can be repeated a plurality of times if necessary, and at this time, coating can be repeated using a plurality of solutions each having a different composition and concentration, to thereby adjust the resin composition and the amount of resin to finally desired ones.

When the resin sheet of the present invention is used as a bonding sheet, for example, two base materials can be adhered with the resin sheet. Each of two base materials is, for example, a laminated board or a printed wiring board. Specifically, for example, the polyfunctional vinyl resin composition is formed into a sheet on a support film by a coating method or the like and then heated for drying or semi-curing to produce a resin sheet. This resin sheet is stacked on a base material (the first base material), the support film is peeled from the resin sheet, and another base material (the second base material) is stacked thereon. That is, the first base material, the resin sheet (the polyfunctional vinyl resin composition), and the second base material are laminated in the order presented. Subsequently, the first base material and the second base material are adhered via the cured product of the polyfunctional vinyl resin composition by heating and curing.

It is also possible to obtain a metal foil with resin from the polyfunctional vinyl resin composition of the present invention and a metal foil. Examples of the metal foil used herein include a copper foil and an aluminum foil. The thickness thereof is not particularly limited, and is in the range of 3 to 200 μm, more preferably 5 to 105 μm.

Examples of the method for producing the metal foil with resin include, but are not particularly limited to, a method in which the polyfunctional vinyl resin composition and, if necessary, other components are uniformly dissolved or dispersed in, for example, an aromatic or a ketone-based solvent, or a mixed solvent thereof, and a metal film is coated therewith and then dried. Coating can be repeated a plurality of times if necessary, and at this time, coating can be repeated using a plurality of solutions each having a different composition and concentration, to thereby adjust the resin composition and the amount of resin to finally desired ones.

A substrate for electronic materials is formed using the laminate of the present invention. The substrate for electronic materials can be suitably used as a component for various electrical and electronic devices, such as mobile phones, PHS, laptops, personal digital assistant (PDA), portable video telephone sets, personal computers, super computers, servers, routers, liquid-crystal projectors, engineering work station (EWS), pagers, word processors, televisions, viewfinder-type or monitor-direct-view-type video tape recorders, electronic notebooks, electronic desk calculators, car navigation equipment, POS terminals, and apparatuses equipped with a touch panel, which are demanded to have reliability in an environment requiring heat resistance and water resistance, and transmission reliability of high frequency signals. In particular, the substrate for electronic materials can be suitably used as a circuit substrate for electrical and electronic devices described above due to excellent dielectric properties, heat resistance stability, dimension stability corresponding to the formation of a circuit with fine pattern, and moldability of the cured product of the present invention. Specific examples thereof include one-side substrates, double-side substrates, multilayer printed substrates, flexible substrates, and build-up substrate. A multilayer circuit board using metal plating for the conductor layer is also included in preferred examples.

### EXAMPLES

The present invention is specifically described with reference to Examples and Comparative Examples, but the present invention is not limited thereto. Unless particularly noted, “parts” represents “parts by mass”, “%” represents “% by mass”, and “ppm” represents “ppm by mass”. Measurement methods were respectively the following measurement methods.

The test conditions of polyvalent hydroxy resins, polyvalent vinyl resins, and cured products will be shown.
(1) Hydroxyl equivalent:
measured in accordance with JIS K 0070 standard, where the unit was expressed by “g/eq.”. Unless particularly noted, the hydroxyl equivalent of a polyvalent hydroxy resin means the phenolic hydroxyl equivalent.
(2) Softening point:
measured in accordance with a ring-and-ball method in JIS K 7234 standard. Specifically, an automatic softening point apparatus (ASP-MG4 manufactured by Meitech Company, Ltd.) was used.
(3) Vinyl equivalent:
measured in accordance with JIS K 0070 standard. Specifically, a sample was allowed to react with a Wijs solution (iodine monochloride solution), allowed to stand in a dark place, and thereafter, excess iodine chloride was reduced to iodine, and an iodine content was titrated with sodium thiosulfate to calculate the iodine value. The iodine value was converted to the vinyl equivalent.
(4) Solvent solubility:
The resin was charged in each of various solvents (acetone (AC), methyl ethyl ketone (MEK), toluene (TL), methylcellosolve (MC), and propylene glycol monomethyl ether acetate (PMA)) so that the solid content concentration (resin/(resin+solvent)×100), namely, the non-volatile content was 60% or 70%, and sufficiently stirred at room temperature, and thereafter whether or not the resin was completely dissolved was visually confirmed. A case of clouding or any insoluble fraction was evaluated as “Poor” and a case of no insoluble fraction was evaluated as “Good”.
(5) Relative permittivity and dielectric tangent:
measured in accordance with IPC-TM-650 2.5.5.9. Specifically, evaluation was made by determining the relative permittivity and the dielectric tangent at a frequency of 1 GHz by a capacitance method by use of a material analyzer (manufactured by AGILENT Technologies).
(6) Glass transition temperature (Tg):
measured in accordance with JIS C6481 standard. Specifically, the glass transition temperature was expressed by the tan δ peak top when measurement was made using a dynamic mechanical analyzer (EXSTAR DMS6100 manufactured by Hitachi High-Technologies Corporation) under temperature rising conditions of 5° C./minute.
(7) GPC (gel permeation chromatography) measurement:
columns (TSKgelG4000H_{XL}, TSKgelG3000H_{XL} and TSKgelG2000H_{XL} manufactured by Tosoh Corporation) connected to the main body (HLC-8220 GPC manufactured by Tosoh Corporation) in series were used, and the column temperature was 40° C. The eluent here used was tetrahydrofuran (THF) at a flow rate of 1 mL/min, and the detector here used was a differential refractive index detector. The measurement specimen here used was 50 μL of one obtained by dissolving 0.1 g of a sample in 10 mL of THF and filtering the solution by a micro filter. Mw and Mn were determined by conversion from the calibration curve determined using standard polystyrene (PStQuick Kit-H manufactured by Tosoh Corporation). GPC-8020 Model II version 6.00 manufactured by Tosoh Corporation was used for data processing.
(8) IR:
using Fourier transform infrared spectroscopy (Spectrum One FT-IR Spectrometer 1760X manufactured by Perkin Elmer Precisely) and diamond ATR, ATR was coated with a sample dissolved in toluene and dried, and thereafter, absorbance at wavenumbers from 650 to 4000 cm⁻¹ was measured.

Abbreviations used in Examples and Comparative Examples are as follows.

### [Aromatic Hydroxy Compound]

P1: Aromatic hydroxy compound obtained in Synthesis Example 1
P2: Aromatic hydroxy compound obtained in Synthesis Example 2
P3: Aromatic hydroxy compound obtained in Synthesis Example 3

### [Polyfunctional Vinyl Resin, Vinyl Compound]

V1: Polyfunctional vinyl resin obtained in Example 1
V2: Polyfunctional vinyl resin obtained in Example 2
V3: Polyfunctional vinyl resin obtained in Example 3
V4: Polyfunctional vinyl resin obtained in Example 4
VH1: Polyfunctional vinyl resin (manufactured by Mitsubishi Gas Chemical Company, Inc., terminal vinylbenzyl ether-modified PPE resin, OPE-2ST, Mn 1187)
VH2: Polyfunctional vinyl resin (manufactured by SABIC Japan LLC, terminal methacrylic-modified PPE resin, SA9000, Mw 1600)
VH3: Vinyl compound (triallyl isocyanurate manufactured by Tokyo Chemical Industry Co., Ltd.)
PO: Organic peroxide (perbutyl P manufactured by NOF CORPORATION)
DO: Organic peroxide (percumyl D manufactured by NOF CORPORATION)
AO: Antioxidant (ADK STAB AO-60 manufactured by ADEKA Corporation)

### Synthesis Example 1

A reaction apparatus including a separable flask made of glass, equipped with a stirrer, a thermometer, a nitrogen blowing tube, a dropping funnel and a cooling tube was loaded with 500 parts of 2,6-xylenol (the following structural formula):

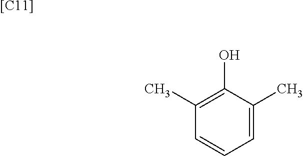

and 7.3 parts of a 47% BF3 ether complex (0.1-fold moles relative to dicyclopentadiene initially added), and the resulting mixture was warmed to 100° C. with stirring. While this temperature was kept, 67.6 parts of dicyclopentadiene (the following structural formula):

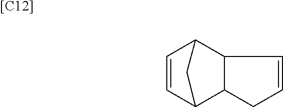

(0.12-fold moles relative to 2,6-xylenol) was dropped for 1 hour. Furthermore, the reaction was made at a temperature of 115 to 125° C. for 4 hours. Thereafter, the resultant was warmed to 200° C. under a reduced pressure of 5 mmHg, to thereby evaporate and remove the unreacted raw material. A product was dissolved by addition of 46.7 parts of methyl isobutyl ketone (MIBK). After 3.3 parts of a 47% BF3 ether complex was loaded, the resultant was warmed to 100° C., and while this temperature was kept, 74.7 parts of dicyclopentadiene was dropped for 1 hour. Furthermore, the reaction was made at 115 to 125° C. for 4 hours. 5 parts of calcium hydroxide was added. Furthermore, 9 parts of an aqueous 10% oxalic acid solution was added. A product was dissolved by addition of 350 parts of MIBK, and washed with water by addition of 120 parts of warm water at 80° C., and an aqueous layer as the lower layer was separated and removed. The resultant was warmed to 120° C. and dehydrated under reflux, subjected to filtration, and then warmed to 160° C. under a reduced pressure of 5 mmHg to evaporate and remove MIBK, and thus 259 parts of red-brown polyvalent hydroxy resin (P1) was obtained.

The polyvalent hydroxy resin (P1) obtained was a resin having a hydroxyl group equivalent of 323 and a softening point of 97° C., and the absorption ratio (A₃₀₄₀/A₁₂₁₀) was 0.27. In GPC, the Mw was 740, the Mn was 490, the content of an n=0 form was 6.6% by area, the content of an n=1 form was 70.1% by area, and the content of an n≥2 form was 23.3% by area. A mass spectrum by ESI-MS (negative) was measured, and the following was confirmed: M−=375, 507, 629, 639, 761.

### Synthesis Example 2

The same reaction apparatus as in Synthesis Example 1 was loaded with 500 parts of 2,6-xylenol and 7.3 parts of a 47% BF3 ether complex, and the resulting mixture was warmed to 100° C. with stirring. While this temperature was kept, 67.6 parts of dicyclopentadiene (0.12-fold moles relative to 2,6-xylenol) was dropped for 1 hour. Furthermore, the reaction was made at a temperature of 115 to 125° C. for 4 hours. Thereafter, the resultant was warmed to 200° C. under a reduced pressure of 5 mmHg, to thereby evaporate and remove the unreacted raw material. A product was dissolved by addition of 46.7 parts of MIBK. After 3.3 parts of a 47% BF3 ether complex was loaded, the resultant was warmed to 100° C., and while this temperature was kept, 56.0 parts of dicyclopentadiene was dropped for 1 hour. Furthermore, the reaction was made at 115 to 125° C. for 4 hours. 5 parts of calcium hydroxide was added. Furthermore, 9 parts of an aqueous 10% oxalic acid solution was added. A product was dissolved by addition of 320 parts of MIBK, and washed with water by addition of 110 parts of warm water at 80° C., and an aqueous tank as the lower layer was separated and removed. The resultant was warmed to 120° C. and dehydrated under reflux, subjected to filtration, and then warmed to 160° C. under a reduced pressure of 5 mmHg to evaporate and remove MIBK, and thus 240 parts of red-brown polyvalent hydroxy resin (P2) was obtained.

The polyvalent hydroxy resin (P2) obtained was a resin having a hydroxyl group equivalent of 276 and a softening point of 94° C., and the absorption ratio (A₃₀₄₀/A₁₂₁₀) was 0.17. In GPC, the Mw was 670, the Mn was 490, the content of an n=0 form was 6.6% by area, the content of an n=1 form was 70.3% by area, and the content of an n≥2 form was 23.1% by area. A mass spectrum by ESI-MS (negative) was measured, and the following was confirmed: M−=375, 507, 629, 639, 761.

### Synthesis Example 3

The same reaction apparatus as in Synthesis Example 1 was loaded with 500 parts of 2,6-xylenol and 7.3 parts of a 47% BF3 ether complex (0.1-fold moles relative to dicyclopentadiene initially added), and the resulting mixture was warmed to 100° C. with stirring. While this temperature was kept, 67.6 parts of dicyclopentadiene (0.12-fold moles relative to 2,6-xylenol) was dropped for 1 hour. Furthermore, the reaction was made at a temperature of 115 to 125° C. for 4 hours. Thereafter, the resultant was warmed to 200° C. under a reduced pressure of 5 mmHg, to thereby evaporate and remove the unreacted raw material. A product was dissolved by addition of 46.7 parts of MIBK. After 3.3 parts of a 47% BF3 ether complex was loaded, the resultant was warmed to 100° C., and while this temperature was kept, 28.0 parts of dicyclopentadiene was dropped for 1 hour. Furthermore, the reaction was made at 115 to 125° C. for 4 hours, and 5 parts of calcium hydroxide was added. Furthermore, 9 parts of an aqueous 10% oxalic acid solution was added. A product was dissolved by addition of 280 parts of MIBK, and washed with water by addition of 100 parts of warm water at 80° C., and an aqueous layer as the lower layer was separated and removed. The resultant was warmed to 120° C. and dehydrated under reflux, subjected to filtration, and then warmed to 160° C. under a reduced pressure of 5 mmHg to evaporate and remove MIBK, and thus 213 parts of red-brown polyvalent hydroxy resin (P3) was obtained.

The polyvalent hydroxy resin (P3) obtained was a resin having a hydroxyl group equivalent of 234 and a softening point of 86° C., and the absorption ratio (A₃₀₄₀/A₁₂₁₀) was 0.11. In GPC, the Mw was 560, the Mn was 470, the content of an n=0 form was 6.2% by area, the content of an n=1 form was 74.0% by area, and the content of an n≥2 form was 19.8% by area. A mass spectrum by ESI-MS (negative) was measured, and the following was confirmed: M−=375, 507, 629, 639, 761.

### Example 1

The same apparatus as in Synthesis Example 1 was loaded with 100 parts of the polyvalent hydroxy resin (P1) obtained in Synthesis Example 1, 37.8 parts of dimethylaminopyridine and 150 parts of toluene, and the temperature of the resulting mixture was raised to 60° C. for dissolution. After the resulting mixture was cooled to 20° C., 71.6 parts of methacrylic anhydride (the following structural formula):

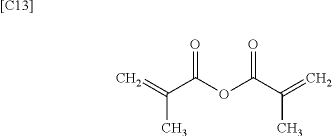

(1.5 equivalents relative to the hydroxyl group equivalent of P1) was dropped for 30 minutes, and the mixture was further allowed to react at 80° C. for 3 hours. The resulting resin was dissolved in 340 parts of toluene, and washed with 210 parts of methanol water having a methanol concentration of 30% by weight. Thereafter, the solvent was distilled off under reduced pressure to obtain 190 parts of the polyfunctional vinyl resin (V1) as a toluene solution having a non-volatile content of 60%.

The polyfunctional vinyl resin (V1) obtained had the hydroxyl group equivalent of 23400, the vinyl equivalent thereof was 420. It was the polyfunctional vinyl resin represented by the formula (1) wherein R1 is a methyl group and i is 2. In GPC, the Mw was 870, the Mn was 510, the content of an n=0 form was 9.8% by area, the content of an n=1 form was 64.6% by area, and the content of an n≥2 form was 25.6% by area.

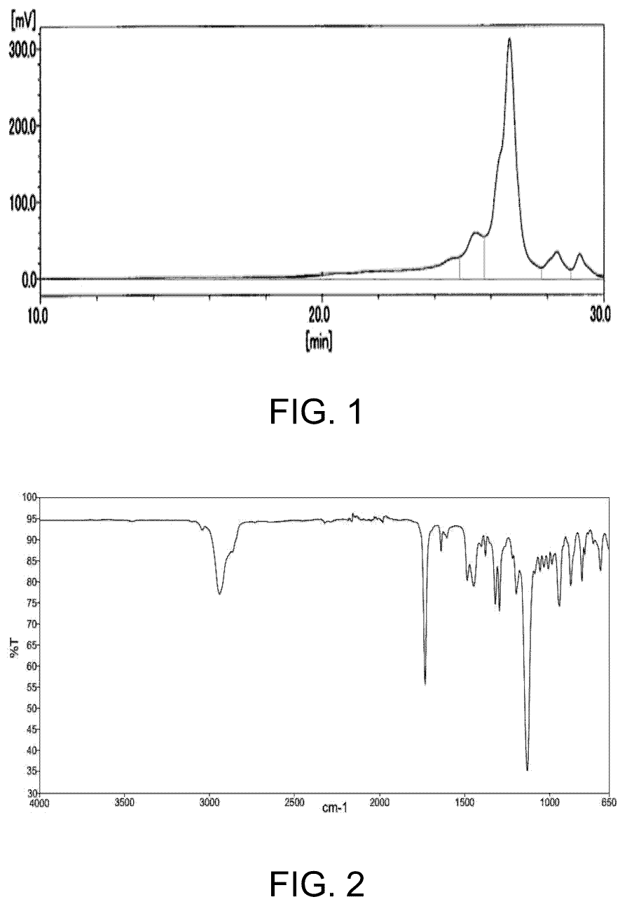

The GPC chart of the polyfunctional vinyl resin (V1) is illustrated in FIG. 1, and the IR chart of the polyfunctional vinyl resin (V1) is illustrated in FIG. 2.

### Example 2

The same apparatus as in Synthesis Example 1 was loaded with 100 parts of the polyvalent hydroxy resin (P2) obtained in Synthesis Example 2, 44.3 parts of dimethylaminopyridine and 150 parts of toluene, and the temperature of the resulting mixture was raised to 60° C. for dissolution. After the resulting mixture was cooled to 20° C., 83.8 parts of methacrylic anhydride (1.5 equivalents relative to the hydroxyl group equivalent of P2) was dropped for 30 minutes, and the mixture was further allowed to react at 80° C. for 3 hours. The resulting resin was dissolved in 380 parts of toluene, and washed with 230 parts of methanol water having a methanol concentration of 30% by weight. Thereafter, the solvent was distilled off under reduced pressure to obtain 220 parts of the polyfunctional vinyl resin (V2) as a toluene solution having a non-volatile content of 60%.

The hydroxyl group equivalent of the polyfunctional vinyl resin (V2) obtained was 22000, the vinyl equivalent thereof was 370. It was the polyfunctional vinyl resin represented by the formula (1) wherein R¹ is a methyl group and i is 2. In GPC, the Mw was 790, the Mn was 510, the content of an n=0 form was 9.8% by area, the content of an n=1 form was 64.8% by area, and the content of an n≥2 form was 25.4% by area.

### Example 3

The same apparatus as in Synthesis Example 1 was loaded with 100 parts of the polyvalent hydroxy resin (P3) obtained in Synthesis Example 3, 52.2 parts of dimethylaminopyridine and 150 parts of toluene, and the temperature of the resulting mixture was raised to 60° C. for dissolution. After the resulting mixture was cooled to 20° C., 98.8 parts of methacrylic anhydride (1.5 equivalents relative to the hydroxyl group equivalent of P3) was dropped for 30 minutes, and the mixture was further allowed to react at 80° C. for 3 hours. The resulting resin was dissolved in 440 parts of toluene, and washed with 250 parts of methanol water having a methanol concentration of 30% by weight. Thereafter, the solvent was distilled off under reduced pressure to obtain 260 parts of the polyfunctional vinyl resin (V3) as a toluene solution having a non-volatile content of 60%.

The hydroxyl group equivalent of the polyfunctional vinyl resin (V3) obtained was 20000, the vinyl equivalent thereof was 330. It was the polyfunctional vinyl resin represented by the formula (1) wherein R¹ is a methyl group and i is 2. In GPC, the Mw was 660, the Mn was 490, the content of an n=0 form was 9.2% by area, the content of an n=1 form was 69.0% by area, and the content of an n≥2 form was 21.8% by area.

### Example 4

The same apparatus as in Synthesis Example 1 was loaded with 100 parts of the polyvalent hydroxy resin (P1) obtained in Synthesis Example 1, 37.8 parts of dimethylaminopyridine and 150 parts of toluene, and the temperature of the resulting mixture was raised to 60° C. for dissolution. After the resulting mixture was cooled to 20° C., 38.8 parts of methacrylic chloride (the following structural formula):

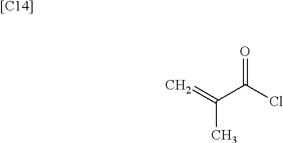

(1.2 equivalents relative to the hydroxyl group equivalent of P1) was dropped for 30 minutes, and the mixture was further allowed to react at 80° C. for 3 hours. The resulting resin was dissolved in 340 parts of toluene, and washed with 210 parts of methanol water having a methanol concentration of 30% by weight. Thereafter, the solvent was distilled off under reduced pressure to obtain 190 parts of the polyfunctional vinyl resin (V4) as a toluene solution having a non-volatile content of 60%.

The hydroxyl group equivalent of the polyfunctional vinyl resin (V4) obtained was 25000, the vinyl equivalent thereof was 425. It was the polyfunctional vinyl resin represented by the formula (1) wherein R¹ is a methyl group and i is 2. In GPC, the Mw was 880, the Mn was 520, the content of an n=0 form was 9.8% by area, the content of an n=1 form was 63.6% by area, and the content of an n≥2 form was 26.6% by area.

The results of the solvent solubilities of the polyfunctional vinyl resins (V1 to V4) obtained in Examples 1 to 4 and that obtained in Comparative Example (VH2) are shown in Table 1.

TABLE 1

| Solvent | Non-volatile content 70% | | | | | Non-volatile content 60% | | | | |
|---|---|---|---|---|---|---|---|---|---|---|
| used | V1 | V2 | V3 | V4 | VH2 | V1 | V2 | V3 | V4 | VH2 |
| AC | Good | Good | Good | Good | Poor | Good | Good | Good | Good | Poor |
| MEK | Good | Good | Good | Good | Good | Good | Good | Good | Good | Good |
| TL | Good | Good | Good | Good | Poor | Good | Good | Good | Good | Good |
| MC | Good | Good | Good | Good | Poor | Good | Good | Good | Good | Poor |
| PMA | Good | Good | Good | Good | Poor | Good | Good | Good | Good | Good |

### Examples 5 to 13 and Comparative Examples 1 to 2

Components were mixed in a compounding ratio (parts) shown in Tables 2 and 3 and dissolved in toluene to thereby obtain a uniform vinyl resin composition varnish having a non-volatile content of 50%. A PET film was coated with the vinyl resin composition varnish obtained, and dried at 130° C. for 5 minutes, and the dried varnish was peeled from the PET film to obtain a resin composition. The resin composition was sandwiched between mirror plates, and cured under reduced pressure at 130° C. for 30 minutes and under application of a pressure of 2 MPa at 220° C. for 100 minutes, to thereby obtain a cured product. The measurement results of the relative permittivity, the dielectric tangent, and the Tg of the cured product obtained are shown in Tables 2 and 3.

TABLE 2

| | Example | Example | Example | Example | Example | Example | Comparative |
|---|---|---|---|---|---|---|---|
| | 5 | 6 | 7 | 8 | 9 | 10 | Example 1 |
| V1 | 75 | 50 | 25 | | | | |
| V2 | | | | 50 | | | |
| V3 | | | | | 50 | | |
| V4 | | | | | | 50 | |
| VH1 | 25 | 50 | 75 | 50 | 50 | 50 | 100 |
| PO | 0.50 | 0.50 | 0.50 | 0.50 | 0.50 | 0.50 | 0.50 |
| AO | 0.20 | 0.20 | 0.20 | 0.20 | 0.20 | 0.20 | 0.20 |
| Relative | 2.50 | 2.54 | 2.57 | 2.60 | 2.63 | 2.55 | 2.59 |
| permittivity | | | | | | | |
| Dielectric | 0.0012 | 0.0015 | 0.0020 | 0.0020 | 0.0024 | 0.0015 | 0.0027 |
| tangent | | | | | | | |
| Tg (° C.) | 235 | 231 | 228 | 255 | 275 | 234 | 182 |

TABLE 3

| | Example | Example | Example | Comparative Example |
|---|---|---|---|---|
| | 11 | 12 | 13 | 2 |
| V1 | 95 | 91 | 83 | |
| VH2 | | | | 95 |
| VH3 | 5 | 9 | 17 | 5 |
| DO | 2.00 | 2.00 | 2.00 | 2.00 |
| Tg (° C.) | 240 | 245 | 254 | 240 |
| Relative | 2.50 | 2.53 | 2.55 | 2.56 |
| permittivity | | | | |
| Dielectric | 0.0013 | 0.0015 | 0.0016 | 0.0016 |
| tangent | | | | |

The polyfunctional vinyl resins in Examples exhibited excellent physical properties of favorable solvent solubility, and low permittivity and low dielectric tangent as compared with Comparative Examples.

### INDUSTRIAL APPLICABILITY

The polyfunctional vinyl resin of the present invention can be utilized as printed substrates, sealing materials, casting materials, and the like in electronic devices, and is particularly useful as materials less in signal loss of electronic components, as electronic materials for useful high-speed telecommunication equipment.

1. A polyfunctional vinyl resin represented by the following general formula (1): 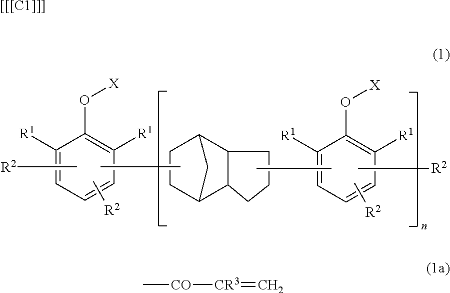
wherein each R¹ independently represents a hydrocarbon group having 1 to 8 carbon atoms; each R² independently represents a hydrogen atom, or a dicyclopentenyl group, and at least one R² is a dicyclopentenyl group; each X independently represents a hydrogen atom or a vinyl group-containing group represented by the formula (1a), and at least one X is a vinyl group-containing group; R³ represents a hydrogen atom or an alkyl group or an alkenyl group having 1 to 8 carbon atoms; and n represents the number of repetitions and an average value thereof is a number of 1 to 5.

2. A method for producing the polyfunctional vinyl resin according to claim 1, comprising reacting dicyclopentadiene at a ratio of 0.23 to 2-fold moles with 2,6-disubstituted phenol represented by the following general formula (2), to obtain a polyvalent hydroxy resin represented by the following general formula (3), and then reacting the resulting polyvalent hydroxy resin with one or more of an acid anhydride represented by the following general formula (4a) or an acid halide represented by the following general formula (4b): 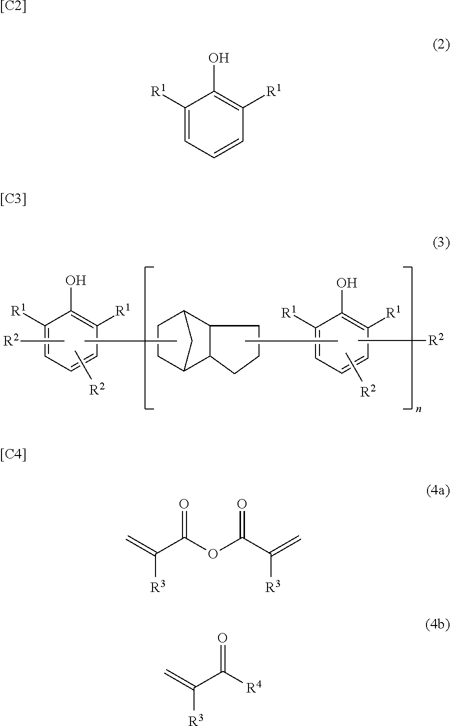
wherein R¹, R², and n each have the same meaning as the definition in the general formula (1); R³ has the same meaning as the definition in the formula (1a); and R⁴ represents a halogen.

3. A polyfunctional vinyl resin composition comprising the polyfunctional vinyl resin according to claim 1 and a radical polymerization initiator as essential components.

4. A cured product obtained by curing the polyfunctional vinyl resin according to claim 1.

5. A prepreg comprising the polyfunctional vinyl resin composition according to claim 3 or a semi-cured product thereof, and a fibrous base material.

6. A resin sheet comprising a resin layer of the polyfunctional vinyl resin composition according to claim 3 or a semi-cured product thereof, and a support film.

7. A laminated board formed by lamination of the prepreg according to claim 5.

8. A cured product obtained by curing the polyfunctional vinyl resin composition according to claim 3.

9. A laminated board formed by lamination of the resin sheet according to claim 6.
